(19) United States
(12) Patent Application Publication
(10) Pub. No.: US 2026/0192486 A1
(43) Pub. Date: Jul. 9, 2026

(54) TRANSPARENT WOOD COMPOSITE, METHOD FOR PREPARING THE SAME, AND OPTICAL FILM COMPRISING THE SAME

(71) Applicants: Hyundai Motor Company, Seoul (KR); Kia Corporation, Seoul (KR); Kumoh National Institute of Technology Industry-Academic Cooperation Foundation, Gumi (KR)

(72) Inventors: Dong Jun Lee, Hwaseong (KR); Youhoon Park, Hwaseong (KR); Seohan Yun, Gumi (KR); Junyong Park, Gumi (KR)

(21) Appl. No.: 19/223,451

(22) Filed: May 30, 2025

(30) Foreign Application Priority Data
Jan. 3, 2025 (KR) 10-2025-0000603

(51) Int. Cl. B27K 3/20; B27K 3/15; B27K 5/00; B27K 5/02; C08L 101/00; F21K 2/00; F21V 9/32; G02F 1/01

(52) U.S. Cl. CPC B27K 3/20; B27K 3/15; B27K 5/003; B27K 5/02; C08L 101/00; F21K 2/005; F21V 9/32; G02F 1/0126

(57) ABSTRACT

Provided is a transparent wood composite including a wood template, and an upconversion material injected into the wood template. The transparent wood composite may include a transparent wood template, and functional particles injected into the transparent wood template, wherein the functional particles may emit visible light when exposed to near-infrared light. Also provided is a method for preparing a transparent wood composite, which may include preparing a wood template, injecting an upconversion material into the wood template, and photocuring. Also provided is an optical film including a transparent wood composite.

### CROSS-REFERENCE TO RELATED APPLICATION

The present application claims under 35 U.S.C. § 119(a) the benefit of Korean Patent Application No. 10-2025-0000603, filed on Jan. 3, 2025 in the Korean Intellectual Property Office, the entire disclosure of which is incorporated herein by reference.

### BACKGROUND

### Technical Field

The present disclosure relates to a transparent wood composite, a method for preparing the same, and an optical film comprising the same.

### Background

Transparent wood composites can be produced by filling the porous structure of wood with a transparent polymer having a refractive index similar to cellulose, thereby reducing scattering.

Transparent wood composites are optically transparent and environmentally friendly and thus can be used for diverse environmentally friendly materials.

Recently, attempts have been made to impart various expanded functionalities to transparent wood composites, beyond simple transparency.

### SUMMARY

According to various embodiments of the present disclosure, a transparent wood composite having a novel optical functionality, a method for preparing the same, and an optical film comprising the same may be provided.

According to various embodiments of the present disclosure, a transparent wood composite having an upconversion luminescence functionality, a method for preparing the same, and an optical film comprising the same may be provided.

A transparent wood composite according to one embodiment of the present disclosure may comprise a wood template, and an upconversion material injected into the wood template.

In the transparent wood composite according to one embodiment of the present disclosure, the upconversion material may comprise one or more of NaYF₄, NaGdF₄, KGdF₄, YOF, BaLaF₅, LaF₃, NaLuF₄, SrF₂, or any combination thereof.

In the transparent wood composite according to one embodiment of the present disclosure, the upconversion material may be dispersed in a polymer.

In the transparent wood composite according to one embodiment of the present disclosure, the polymer may comprise one or more of a photocurable resin, a thermosetting resin, a thermoplastic resin, an environmentally friendly polymer, or any combination thereof.

In the transparent wood composite according to one embodiment of the present disclosure, the wood template may be a bleached wood template.

The transparent wood composite according to one embodiment of the present disclosure may have a visible light transmittance of 70% to 85%.

The transparent wood composite according to one embodiment of the present disclosure may have a haze of 80% to 96%.

A transparent wood composite according to one embodiment of the present disclosure may comprise a transparent wood template, and functional particles injected into the transparent wood template, wherein the functional particles may emit visible light when exposed to near-infrared light.

A method for preparing a transparent wood composite according to one embodiment of the present disclosure may comprise preparing a wood template, injecting an upconversion material into the wood template, and photocuring.

The method may further include bleaching the wood template with a bleaching agent prior to injecting the upconversion material into the wood template.

The bleaching agent may include at least one selected from the group consisting of sodium hydroxide (NaOH) and hydrogen peroxide (H2O2).

Injecting the upconversion material may include: preparing a mixed solution in which the upconversion material and a polymer are mixed; impregnating the wood template with the mixed solution; and performing degassing and pressure restoration by applying a vacuum.

The polymer may be selected from the group consisting of a photocurable resin, a thermosetting resin, a thermoplastic resin, an environmentally friendly polymer, or any combination thereof.

The upconversion material may include functional particles doped with one or more dopants selected from the group consisting of Yb3+, Er3+, and Tm3+.

The method may further include photocuring the upconversion material using an ultraviolet lamp having a wavelength of from 100 nm to 400 nm and an irradiation dose of from 2.0 J/cm2 to 5.0 J/cm2.

Degassing may be performed at a pressure of less than 2 Pa for a time of 5 minutes to 30 minutes and may be repeated two to seven times to replace distilled water in cell walls of the wood template with the upconversion material.

The method may further include washing the bleached wood template with at least one selected from the group consisting of distilled water and ethanol and performing ultrasonic washing after bleaching.

The upconversion material may be selected from the group consisting of NaYF4, NaGdF4, KGdF4, YOF, BaLaF5, LaF3, NaLuF4, SrF2, or any combination thereof.

The upconversion material may be included in an amount of 0.1 wt % to 20 wt % relative to the total weight of the polymer.

An optical film according to one embodiment of the present disclosure may comprise a transparent wood composite.

A transparent wood composite according to various embodiments of the present disclosure may have improved optical clarity.

A transparent wood composite according to various embodiments of the present disclosure may emit visible light when exposed to near-infrared light.

A transparent wood composite of the present disclosure may be utilized as a general-purpose basic material for, for example, mobility-related anticounterfeiting systems, encryption systems, smart windows, and ambient lighting.

As discussed, the method and system suitably include use of a controller or processer.

The effects of the present disclosure are not limited to those mentioned above, and other effects not mentioned can be clearly understood by those skilled in the art from the following description.

### BRIEF DESCRIPTION OF THE DRAWINGS

The foregoing and other embodiments, features, and advantages of the disclosure, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. Like reference numbers and designations in the various drawings indicate like elements.

FIG. 1 is a perspective view of a transparent wood composite according to some embodiments of the present disclosure.

FIG. 2 is a schematic diagram illustrating that a transparent wood composite according to some embodiments of the present disclosure emits visible light when exposed to near-infrared light.

FIG. 3 is a diagram illustrating a method for preparing a transparent wood composite according to some embodiments of the present disclosure.

FIG. 4 shows digital images, microstructure images, and EDS mapping images of transparent wood composites prepared with different concentrations of an upconversion material.

FIG. 5 shows images captured after irradiating transparent wood composites prepared with different concentrations of the upconversion material with normal light and near-infrared light, respectively.

FIG. 6 is a graph showing a luminescence intensity according to concentration of the upconversion material.

In FIG. 7, (a) is a photograph showing luminescence of a transparent wood composite using red-luminescent UCNPs, (b) is a photograph showing luminescence of a transparent wood composite using green-luminescent UCNPs, and (c) is a photograph showing luminescence of a transparent wood composite using blue-luminescent UCNPs.

FIG. 8 is a graph measuring visible light transmittance and haze of transparent wood composites prepared with different concentrations of the upconversion material.

### DETAILED DESCRIPTION

Embodiments described in the present specification can be modified into various different forms, and the technology according to exemplary embodiments is not limited to the embodiments described herein. The exemplary embodiments are provided to make the description of the present disclosure thorough and to fully convey the scope of the present disclosure to those skilled in the art.

Additionally, singular forms used in the specification and the appended claims are intended to include plural forms unless the context clearly indicates otherwise.

In addition, numerical ranges used in this specification include the lower and upper limits and all values within the range, increments logically derived from the form and breadth of the defined range, all doubly limited values, and all possible combinations of the upper and lower limits of numerically limited ranges specified in different forms. Unless specifically defined in this specification, values outside the defined numerical ranges that may occur due to experimental error or rounding off of values are also included within the defined numerical ranges.

Furthermore, reference throughout the specification to “including,” “comprising,” or “having” a constituent element means that, unless specifically stated to the contrary, other constituent elements are not excluded and may be included.

Furthermore, terms including ordinals such as first, second, etc. may be used to describe various elements, but the elements are not limited by these terms. These terms are only used to distinguish one element from another.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

According to various embodiments of the present disclosure, a transparent wood composite having a novel optical functionality and a method for preparing the same may be provided.

According to various embodiments of the present disclosure, a transparent wood composite having an upconversion luminescence functionality and a method for preparing the same may be provided.

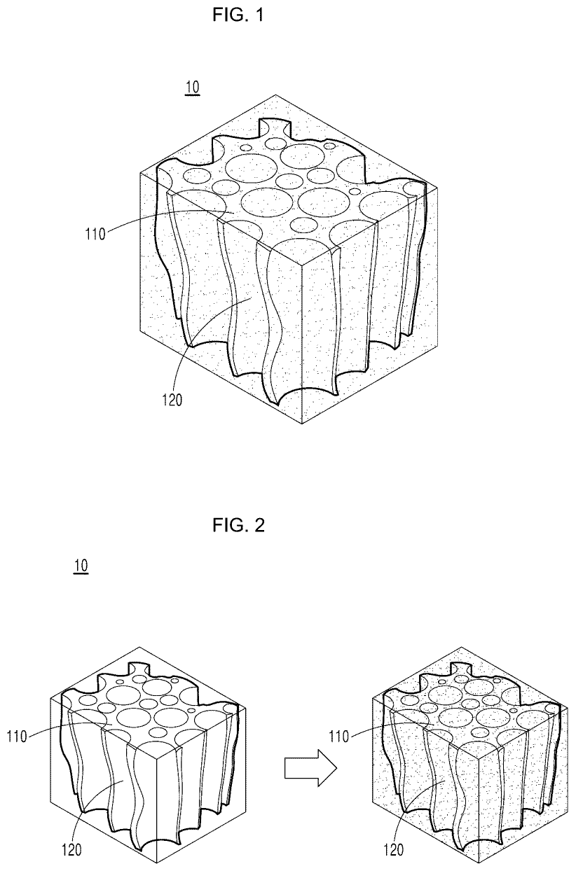

FIG. 1 is a perspective view of a transparent wood composite according to one embodiment of the present disclosure.

Referring to FIG. 1, a transparent wood composite (10) according to various embodiments of the present disclosure may comprise a wood template (110) and an upconversion material (120).

The wood template (110) may comprise a wood having an open pore structure. For example, the wood template (110) may comprise various woods such as balsa wood (longitudinal), paulownia, or fir.

The wood template (110) may be a transparent wood template. The wood template (110) may be a bleached wood template. The wood template (110) may be a bleached wood template obtained by treating with a bleaching agent and exposing to ultraviolet rays. Here, the bleaching agent may be, for example, NaOH or H₂O₂, etc.

The upconversion material (120) may be upconversion nanoparticles (UCNPs). The upconversion material (120) may be injected into the wood template (110). The upconversion material (120) may be impregnated into the cell walls of the wood template (110). The upconversion material (120) may impart an upconversion functionality to the transparent wood composite (10). The upconversion material (120) may impart high temperature resistance to the wood template (10).

The upconversion material (120) may be functional particles having an upconversion functionality. The upconversion material (120) may be functional particles that emit visible light when exposed to near-infrared light. In other words, the upconversion material (120) may be a material that emits a wavelength of 400 nm to 700 nm when exposed to a wavelength of 750 nm to 2500 nm.

The upconversion material (120) may be an organic material, an inorganic material, or an organic-inorganic material that can be dispersed in a liquid polymer medium. The upconversion material (120) may comprise one or more of NaYF₄, NaGdF₄, KGdF₄, YOF, BaLaF₅, LaF₃, NaLuF₄, SrF₂, or any combination thereof. A luminescence color of the transparent wood composite (10) may be variously adjusted across the entire visible light range depending on the type of upconversion material (120).

The upconversion material (120) may have a shape such as a spherical, hexagonal, or rod shape, corresponding to cubic phase and hexagonal phase. The upconversion material (120) may have a particle size of 50 nm to 400 nm. The shape and particle size of the upconversion material (120) may vary depending on a hydrothermal synthesis time.

The upconversion material (120) may be dispersed in a polymer. The upconversion material (120) may be dispersed in a polymer and then injected into the wood template (110).

The polymer may comprise one or more of a photocurable resin, a thermosetting resin, a thermoplastic resin, an environmentally friendly polymer, or any combination thereof. In one example, the polymer may comprise a polyurethane-based photocurable resin.

The upconversion material (120) may be included in an amount of 0.1 wt % to 20 wt %, 0.1 wt % to 15 wt %, 0.1 wt % to 10 wt %, 0.1 wt % to 5 wt %, or 0.1 wt % to 3 wt % relative to the total weight of the polymer.

The luminescence intensity of the transparent wood composite (10) may vary depending on an injection concentration of the upconversion material (120). For example, the luminescence intensity of the transparent wood composite (10) may improve as the injection concentration of the upconversion material (120) increases.

The upconversion material (120) may further comprise a dopant. For example, the upconversion material (120) may be doped with a dopant such as Yb³⁺, Er³⁺, and Tm³⁺ in a NaYF₄ host lattice. The luminescence color of the transparent wood composite (10) may vary depending on the type of dopant doped into the upconversion material (120) and/or the concentration of the dopant. For example, to achieve red luminescence, the upconversion material (120) may be NaYF₄ doped with Yb³⁺ and Er³⁺ as dopants. Specifically, the upconversion material (120) may be NaYF₄ doped with 10 mol % to 30 mol % of Yb³⁺ and 40 mol % to 60 mol % of Er³⁺ as dopants. Alternatively, the upconversion material (120) may be NaYF₄ doped with 15 mol % to 25 mol % of Yb³⁺ and 45 mol % to 55 mol % of Er³⁺ as dopants.

To achieve green luminescence, the upconversion material (120) may be NaYF₄ doped with Yb³⁺ and Er³⁺ as dopants. Specifically, upconversion material (120) may be NaYF₄ doped with 10 mol % to 30 mol % of Yb³⁺ and 1 mol % to 5 mol % of Er³⁺ as dopants. Alternatively, the upconversion material (120) may be NaYF₄ doped with 15 mol % to 25 mol % of Yb³⁺ and 2 mol % to 4 mol % of Er³⁺ as dopants.

To achieve blue luminescence, the upconversion material (120) may be NaYF₄ doped with Yb³⁺ and Tm³⁺ as dopants. Specifically, the upconversion material (120) may be NaYF₄ doped with 10 mol % to 30 mol % of Yb³⁺ and 0.05 mol % to 3 mol % of Tm³⁺ as dopants. Alternatively, the upconversion material (120) may be NaYF₄ doped with 15 mol % to 25 mol % of Yb³⁺ and 0.1 mol % to 1 mol % of Tm³⁺ as dopants.

The transparent wood composite (10) of the present disclosure may have a visible light transmittance of 70% to 85%, 74% to 83%, or 76% to 80%.

The transparent wood composite (10) of the present disclosure may have a haze of 80% to 96%, 84% to 95%, or 89% to 93%.

Through the visible light transmittance and haze within the above-described range of the transparent wood composite (10) of the present disclosure, improved optical clarity may be achieved.

FIG. 2 is a schematic diagram illustrating that a transparent wood composite according to one embodiment of the present disclosure emits visible light when exposed to near-infrared light.

Referring to FIG. 2, the transparent wood composite (10) of the present disclosure may emit visible light through the upconversion material (120) when exposed to near-infrared light.

Accordingly, the transparent wood composite (10) of the present disclosure may be utilized as a general-purpose basic material for, for example, mobility-related anticounterfeiting systems, encryption systems, smart windows, and ambient lighting.

An optical film according to one embodiment of the present disclosure may comprise a transparent wood composite as described above. Here, the optical film may be applied to mobility-related anticounterfeiting systems, encryption systems, smart windows, and ambient lighting, etc.

Hereinafter, a method for preparing a transparent wood composite according to various embodiments of the present disclosure will be described.

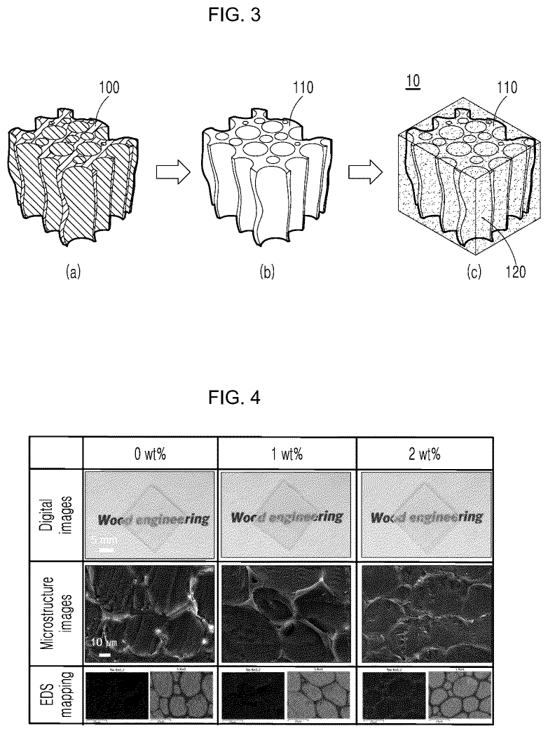

FIG. 3 is a diagram illustrating a method for preparing a transparent wood composite according to one embodiment of the present disclosure.

A method for preparing a transparent wood composite according to various embodiments of the present disclosure may comprise preparing a wood template, injecting an upconversion material into the wood template, and photocuring.

Referring to (a) in FIG. 3, in preparing a wood template (100), wood having an open pore structure may be prepared. For example, in the preparation of the wood template (100), various types of wood such as balsa wood (longitudinal), paulownia, or fir may be prepared.

Referring to (b) in FIG. 3, the preparing of the wood template (100) may comprise bleaching. In the bleaching, a bleached wood template (110) may be prepared using a bleaching agent and ultraviolet rays on the wood template (100). For example, in the bleaching, the bleached wood template (110) may be prepared by treating a surface of the wood template (100) with NaOH and H₂O₂, etc. and exposing to ultraviolet rays.

After the bleaching, the method may further comprise washing. In the washing, the bleached wood template (110) may be washed using ultrasonic waves. For example, in the washing, the bleached wood template (110) may be immersed in distilled water and/or ethanol and ultrasonically washed. Next, the washed wood template may be immersed in distilled water and heated. This allows the distilled water to penetrate into the cell walls of the wood template.

Referring to (c) in FIG. 3, in the injecting, the upconversion material (120) may be injected into the bleached wood template (110). Specifically, the injecting may comprise preparing a mixed solution in which the upconversion material (120) and a polymer are mixed, impregnating the wood template with the mixed solution, and performing degassing and pressure restoration by applying a vacuum.

In preparing the mixed solution, a mixed solution in which the upconversion material is mixed in various concentrations into the polymer may be prepared.

The upconversion material may be functional particles having an upconversion functionality. The upconversion material may be functional particles that emit visible light when exposed to near-infrared light. In other words, the upconversion material may be a material that emits a wavelength of 400 nm to 700 nm when exposed to a wavelength of 750 nm to 2500 nm.

The upconversion material may be an organic material, an inorganic material, or an organic-inorganic material that can be dispersed in a liquid polymer medium. The upconversion material may comprise one or more of NaYF₄, NaGdF₄, KGdF₄, YOF, BaLaF₅, LaF₃, NaLuF₄, SrF₂, or any combination thereof.

The polymer may comprise one or more of a photocurable resin, a thermosetting resin, a thermoplastic resin, an environmentally friendly polymer, or any combination thereof. The photocurable resin may, for example, be one or more of SU-8, epoxy acrylate, polyurethane acrylate (PUA), acrylic ester (including photocurable grades of PMMA), unsaturated polyester resin, photocurable polydimethylsiloxane (PDMS), Norland Optical adhesive, or any combination thereof. The thermosetting resin may be one or more of bisphenol-A epoxy resin, novolac epoxy resin, resole phenolic resin, novolac phenolic resin, polyimide (PI, including Kapton®), polybenzimidazole (PBI), thermosetting polyurethane, thermosetting PDMS, Norland Optical Adhesive, or any combination thereof. The thermoplastic resin may be one or more of polyvinyl alcohol (PVA), polymethyl methacrylate (PMMA), polycarbonate (PC), high-density polyethylene (HDPE), low-density polyethylene (LDPE), polypropylene (PP), polystyrene (PS), nylon (Nylon 6, Nylon 66), polyvinyl chloride (PVC), polytetrafluoroethylene (PTFE), polyoxymethylene (POM), or any combination thereof. In one example, the polymer may comprise a polyurethane-based photocurable resin.

The upconversion material may be included in an amount of 0.1 wt % to 20 wt %, 0.1 wt % to 15 wt %, 0.1 wt % to 10 wt %, 0.1 wt % to 5 wt %, or 0.1 wt % to 3 wt % relative to the total weight of the mixed solution.

The concentration of the upconversion material may be varied depending on a desired luminescence intensity for a final prepared transparent wood composite.

The upconversion material may further comprise a dopant. For example, the upconversion material may be doped with dopants such as Yb³⁺, Er³⁺, and Tm³⁺, etc. The type and/or concentration of the dopant may be varied depending on the desired luminescence color for the final prepared transparent wood composite.

In the impregnating the wood template with the mixed solution, the mixed solution may be impregnated into the wood template prepared as above.

Next, in performing degassing and pressure restoration by applying a vacuum, a high vacuum pump may be used to apply a vacuum to the wood template impregnated with the mixed solution, and degassing and pressure restoration may be performed. The application of the vacuum may be performed using a high vacuum pump exceeding 2 Pa. Degassing may be performed at a pressure of less than 2 Pa for 5 minutes to 1 hour, for 5 minutes to 30 minutes, or for 5 minutes to 15 minutes. Pressure restoration is a process for restoring the pressure to normal pressure and may be performed for 5 minutes to 1 hour, 5 minutes to 30 minutes, or 5 minutes to 15 minutes. The degassing and pressure restoration may be performed multiple times. For example, the degassing and pressure restoration may be performed two to seven times. This allows the distilled water that has penetrated into the cell walls of the wood template to be replaced by the polymer comprising the upconversion material.

Next, in the photocuring, photocuring may be performed using an ultraviolet lamp. For example, photocuring may be performed using an ultraviolet lamp with a wavelength of 100 nm to 400 nm and an irradiation dose of 2.0 J/cm² to 5.0 J/cm².

Through the method for preparing a transparent wood composite according to various embodiments of the present disclosure, a transparent wood composite having a visible light transmittance of 70% to 85%, 74% to 83%, or 76% to 80% may be prepared.

Through the method for preparing a transparent wood composite according to various embodiments of the present disclosure, a transparent wood composite having a haze of 80% to 96%, 84% to 95%, or 89% to 93% may be prepared.

Through the method for preparing a transparent wood composite according to various embodiments of the present disclosure, a transparent wood composite having improved optical clarity may be prepared.

Through the method for preparing a transparent wood composite according to various embodiments of the present disclosure, a transparent wood composite that emits visible light when exposed to near-infrared light may be prepared.

Hereinafter, the present disclosure will be described in more detail by means of examples. However, the following examples and experimental examples are provided merely to describe the present disclosure in more detail, and the scope of the present disclosure is not limited by the following examples and experimental examples.

### Example: Preparing a Transparent Wood Composite

Balsa wood (longitudinal) was prepared by being cut into 1 mm thick and 2 cm wide pieces using a wood template. 10% NaOH was applied to both sides of the wood template using a brush, and 35% H₂O₂ (0.5 mL/cm²) was sprayed on the surface and exposed to an ultraviolet lamp (λ=365 nm) for 1 hour, and a bleached wood template was obtained.

The bleached wood template was placed in distilled water and ethanol, and ultrasonic washing was performed 3 times for approximately 60 seconds each time. The washed wood template was then again placed in a beaker containing distilled water, boiled for approximately 10 minutes, and then stored at room temperature to allow the distilled water to penetrate into the cell walls.

As the polymer, Norland Optical Adhesive 89H (n=1.51 @ 589 nm), which is a polyurethane-based photocurable commercial resin, was prepared. As the upconversion material, NaYF₄-based upconversion nanoparticles prepared via a hydrothermal synthesis method were prepared.

Mixed solutions were prepared in which the upconversion material was mixed at concentrations of 0 wt %, 1 wt %, and 2 wt %, respectively, with respect to the total weight of the polymer.

The wood template was loaded into a petri dish containing a mixed solution (2 mL/ea) comprising the polymer mixed with the upconversion material and placed in a desiccator. Thereafter, a high vacuum pump (>2 Pa) was operated to perform degassing for 10 minutes and pressure restoration for 10 minutes, repeated three times, and the distilled water that had penetrated the cell walls of the wood template was replaced with a mixed solution.

Thereafter, photocuring (3.5 J/cm²) was performed using an ultraviolet lamp (λ=365 nm) to obtain a transparent wood composite injected with an upconversion material-based polymer.

### Experimental Example 1

FIG. 4 shows digital images, microstructure images, and EDS mapping images of transparent wood composites prepared with different concentrations of the upconversion material.

Referring to FIG. 4, for transparent wood composites in which the concentration of the upconversion material is 1 wt % and 2 wt %, respectively, with respect to the total weight of the polymer, it can be confirmed that the mixed solution of the upconversion material and the polymer was successfully impregnated into the cell walls of the wood template. Additionally, it can be confirmed through the EDS mapping images that as the concentration of the upconversion material increases, the detected intensity of the Na element is enhanced.

### Experimental Example 2

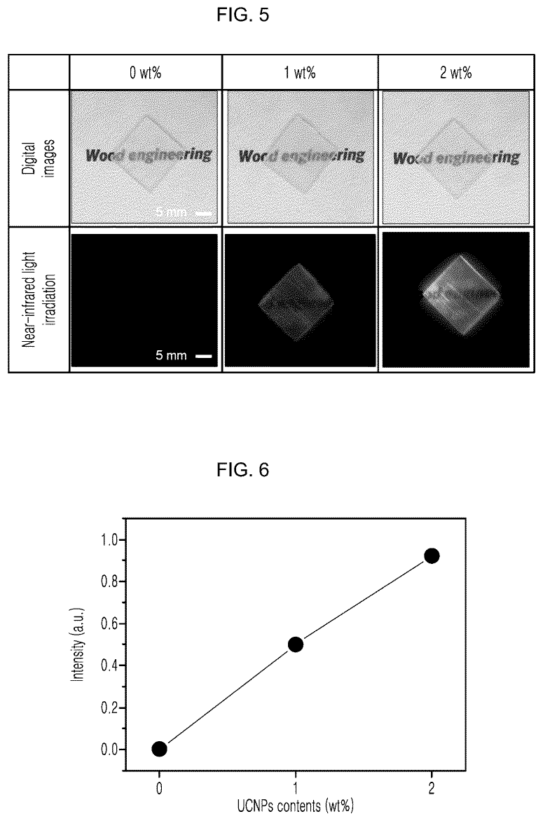

FIG. 5 shows images captured after irradiating transparent wood composites prepared with different concentrations of the upconversion material with normal light and near-infrared light, respectively. FIG. 6 is a graph showing a luminescence intensity according to concentration of the upconversion material.

Referring to FIGS. 5 and 6, for transparent wood composites in which the concentration of the upconversion material (UCNP content) is 1 wt % and 2 wt %, respectively, with respect to the total weight of the polymer, it can be confirmed that visible light is emitted upon irradiation with near-infrared light having a wavelength of 980 nm. In particular, it was confirmed that as the concentration of the upconversion material increases, the luminescence intensity of the transparent wood composite is enhanced.

### Experimental Example 3

FIG. 7 shows images of luminescence color according to type of upconversion material.

As the upconversion material, upconversion nanoparticles (UCNPs) having the compositions shown in Table 1 below were prepared. In other words, the UCNPs in Table 1 below were prepared by controlling the content (mol %) of Yb³⁺, Er³⁺, and Tm³⁺ as dopants in an NaYF₄ host lattice.

TABLE 1

| | Y³⁺ | Yb³⁺ | Er³⁺ | Tm³⁺ |
|---|---|---|---|---|
| | mol % | mol % | mol % | mol % |
| Red-luminescent | 30 | 20 | 50 | — |
| UCNP | | | | |
| Green-luminescent | 77 | 20 | 3 | — |
| UCNP | | | | |
| Blue-luminescent | 79.5 | 20 | — | 0.5 |
| UCNP | | | | |

Luminescence was confirmed for transparent wood composites in which the UCNPs in Table 1 above were mixed at 3 wt % with respect to the total weight of the polymer.

In FIG. 7, (a) is a photograph showing a luminescence of the transparent wood composite using the red-luminescent UCNPs of Table 1 above, (b) is a photograph showing the luminescence of the transparent wood composite using the green-luminescent UCNPs, and (c) is a photograph showing the luminescence of the transparent wood composite using the blue-luminescent UCNPs.

Referring to FIG. 7, it was confirmed that by controlling the content (mol %) of Yb³⁺, Er³⁺, and Tm³⁺, various colors may be emitted, including the three primary colors of light (RGB).

### Experimental Example 4

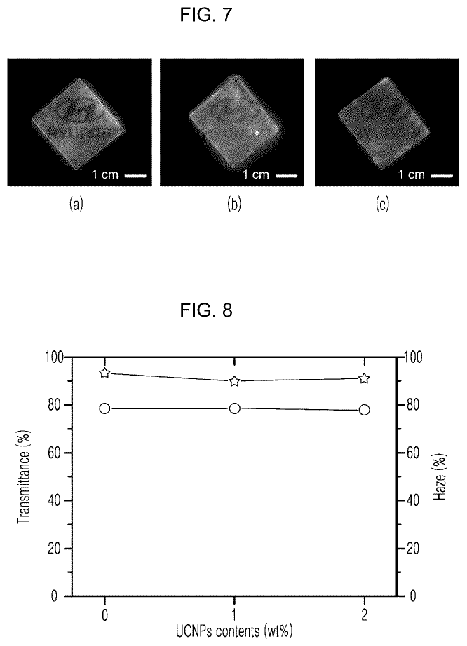

FIG. 8 is a graph measuring visible light transmittance (circles) and haze (stars) of transparent wood composites prepared with different concentrations of the upconversion material.

Referring to FIG. 8, it was confirmed that when the concentration of the upconversion material was adjusted within the range of 0% to 2%, the visible light transmittance of the transparent wood composite was approximately 78%±2%. Additionally, the haze was confirmed to be approximately 91%±2%.

Embodiments of the present disclosure have been described above with reference to the drawings. These are exemplary in nature, and the present disclosure is not limited to the embodiments and the content of the drawings described above.

It will be apparent to those skilled in the art that modifications can be made to the present disclosure within the scope of the disclosed technical idea. The described embodiments should be considered as part of the present disclosure, but the scope of the present disclosure should not be defined solely by the described embodiments.

The scope of the present disclosure should be determined by the technical idea set forth in the claims. Further, in describing the embodiments of the present disclosure, even if actions or effects according to the configuration are not explicitly described, actions or effects that can be predicted from the described configurations should also naturally be recognized as included in the present disclosure.

What is claimed is:

1. A transparent wood composite, comprising:
a wood template; and
an upconversion material injected into the wood template.

2. The transparent wood composite of claim 1, wherein the upconversion material comprises one or more g of NaYF₄, NaGdF₄, KGdF₄, YOF, BaLaF₅, LaF₃, NaLuF₄, and SrF₂, or any combination thereof.

3. The transparent wood composite of claim 1, wherein the upconversion material is dispersed in a polymer.

4. The transparent wood composite of claim 3, wherein the polymer comprises one or more of a photocurable resin, a thermosetting resin, a thermoplastic resin, an environmentally friendly polymer, or any combination thereof.

5. The transparent wood composite of claim 1, wherein the wood template is a bleached wood template.

6. The transparent wood composite of claim 1, wherein the transparent wood composite has a visible light transmittance of about 70% to 85%.

7. The transparent wood composite of claim 1, wherein the transparent wood composite has a haze of about 80% to 96%.

8. A transparent wood composite comprising:
a transparent wood template; and
functional particles injected into the transparent wood template,
wherein the functional particles emit visible light when exposed to near-infrared light.

9. A method for preparing a transparent wood composite, the method comprising:
preparing a wood template;
injecting an upconversion material into the wood template; and
photocuring.

10. The method of claim 9, further comprising bleaching the wood template with a bleaching agent prior to injecting the upconversion material into the wood template.

11. The method of claim 10, wherein the bleaching agent comprises at least one selected from the group consisting of sodium hydroxide (NaOH) and hydrogen peroxide (H₂O₂).

12. The method of claim 9, wherein injecting the upconversion material comprises:
preparing a mixed solution in which the upconversion material and a polymer are mixed;
impregnating the wood template with the mixed solution; and
performing degassing and pressure restoration by applying a vacuum.

13. The method of claim 12, wherein the polymer is selected from the group consisting of a photocurable resin, a thermosetting resin, a thermoplastic resin, an environmentally friendly polymer, or any combination thereof.

14. The method of claim 9, wherein the upconversion material comprises functional particles doped with one or more dopants selected from the group consisting of Yb³⁺, Er³⁺, and Tm³⁺.

15. The method of claim 9, further comprising photocuring the upconversion material using an ultraviolet lamp having a wavelength of from 100 nm to 400 nm and an irradiation dose of from about 2.0 J/cm² to 5.0 J/cm².

16. The method of claim 9, wherein degassing is performed at a pressure of less than 2 Pa for a time of 5 minutes to 30 minutes and is repeated two to seven times to replace distilled water in cell walls of the wood template with the upconversion material.

17. The method of claim 9, further comprising washing the bleached wood template with at least one selected from the group consisting of distilled water and ethanol and performing ultrasonic washing after bleaching.

18. The method of claim 9, wherein the upconversion material is selected from the group consisting of NaYF₄, NaGdF₄, KGdF₄, YOF, BaLaF₅, LaF₃, NaLuF₄, SrF₂, or any combination thereof.

19. The method of claim 9, wherein the upconversion material is included in an amount of about 0.1 wt % to 20 wt % relative to a total weight of the polymer.

20. An optical film comprising a transparent wood composite according to claim 1.
